(19) United States
(12) Patent Application Publication
(10) Pub. No.: US 2026/0051262 A1
(43) Pub. Date: Feb. 19, 2026

(54) XR-BASED SEMICONDUCTOR MANUFACTURING PROCESS TRAINING DEVICE AND PROVISION METHOD THEREOF

(71) Applicant: LEtuiN Edu Co., Ltd., Seoul (KR)

(72) Inventors: Jun Ho KIM, Seoul (KR); Jeong Won SEO, Seoul (KR)

(21) Appl. No.: 18/801,856

(22) Filed: Aug. 13, 2024

(51) Int. Cl. G09B 19/00; G06F 3/01

(52) U.S. Cl. CPC G09B 19/00; G06F 3/011; G06F 3/017

(57) ABSTRACT

An XR-based semiconductor manufacturing process training device according to an embodiment of the present invention is configured to determine set values for parameters based on user input data, identify the spec data to which the set values belong among at least one spec data corresponding to the parameters defined in each manufacturing process, assign weights corresponding to the spec data to the set values, and calculate and display final data based on the first motion information and the weighted set values.

### BACKGROUND

### Technical Field

The present invention relates to a method of providing training for semiconductor manufacturing processes through a device based on Extended Reality (XR).

### Background of the Invention

Extended Reality (XR) is a term that encompasses Virtual Reality (VR), Augmented Reality (AR), and Mixed Reality (MR). Initially emerging in the entertainment and gaming industries, it has recently expanded into various fields such as education, healthcare, military training, and manufacturing. Through devices implementing XR technology, it is possible to provide immersive experiences by combining the user's real world with digital content or creating entirely new virtual worlds.

Meanwhile, the semiconductor manufacturing process consists of extremely complex and precise procedures, requiring highly specialized knowledge and skilled techniques. Traditional methods of training for semiconductor manufacturing processes, which focus on theory-based lectures and limited practical opportunities, have limitations in understanding the complexity of the actual processes and improving proficiency. Additionally, training using actual process equipment involves significant costs and risks, and it is challenging to quickly adapt training to process changes or the introduction of new technologies.

### SUMMARY

### Objectives of the Invention

The present invention utilizes XR technology to virtually recreate a realistic semiconductor manufacturing process environment, providing users with an environment where they can directly simulate and practice various processes without risk.

The problems to be solved by this disclosure are not limited to those mentioned above, and other problems not mentioned will be clearly understood by those skilled in the art from the following description.

### Means for Solving the Problem

In a preferred embodiment of the present invention, the XR-based semiconductor manufacturing process training device comprises: a memory for storing virtual visual data, at least one specification data(spec data) corresponding to parameters defined in each manufacturing process, and weights corresponding to the spec data; a first sensor for sensing first motion information related to the user's movement; an input unit for receiving the user's input data; a processor for determining set values for the parameters based on the input data, identifying the spec data to which the set values belong, assigning weights corresponding to the spec data to the set values, and calculating final data based on the first motion information and the weighted set values; and a display unit for displaying visual data corresponding to the virtual visual data and the final data.

In one embodiment, the virtual visual data may include 3D animation data.

In one embodiment, the input data may include process information selected by the user among the manufacturing processes and spec setting information related to the parameters.

In one embodiment, the processor may determine whether the spec data to which the set values belong matches the spec data with the highest weight.

In one embodiment, the display unit may display predetermined first content for matching parameters if the spec data to which the set values belong matches the spec data with the highest weight, and predetermined second content for non-matching parameters if they do not match.

In one embodiment, the display unit may display predetermined third content if the number of non-matching parameters exceeds a predetermined number in each manufacturing process.

In one embodiment, the processor may further generate user recommendation data that includes the spec data with the highest weight assigned to the parameter for which the predetermined second content or the predetermined third content is displayed.

In one embodiment, the parameters defined in each manufacturing process, at least one spec data corresponding to the parameters, and the weights corresponding to the spec data are labeled as training data, and the labeled training data is batch processed into a learning model. When the user recommendation data is extracted by receiving the final data, the user recommendation data is tested and verified based on a ground truth set established by the user's evaluation of the user recommendation data. Feedback data is generated based on the testing and verification, and the parameters of the learning model are tuned based on the feedback data to perform supervised learning of the user recommendation data for the user's final data.

In one embodiment, the first sensor may be a gyroscope-based sensor.

In one embodiment, the apparatus may further include a second sensor for sensing second motion information related to the user's gestures.

In one embodiment, the second sensor may be an AI-based vision camera sensor.

In one embodiment, calculating the final data based on the first motion information includes calculating the final data when the pre-stored motion information matching data matches the first motion information performed in each manufacturing process.

In one embodiment, the memory may store the final data for each user account (ID).

A method for training in a semiconductor manufacturing process using XR technology according to a preferred embodiment of the present invention comprises: storing virtual visual data, at least one spec data corresponding to parameters defined in each manufacturing process, and weights corresponding to the spec data; sensing first motion information related to the user's movement; receiving the user's input data; determining set values for the parameters based on the input data, identifying the spec data to which the set values belong, assigning weights corresponding to the spec data to the set values, and calculating final data based on the first motion information and the weighted set values; and displaying visual data corresponding to the virtual visual data and the final data.

In one embodiment, the step of calculating the final data includes determining whether the spec data to which the set values belong matches the spec data with the highest weight.

In one embodiment, the method further includes displaying predetermined first content for matching parameters when the spec data to which the set values belong matches the spec data with the highest weight, and displaying predetermined second content for non-matching parameters when they do not match.

In one embodiment, the method further includes displaying predetermined third content if the number of non-matching parameters exceeds a predetermined number in each manufacturing process.

In one embodiment, the method further includes labeling each manufacturing process, the parameters defined in each manufacturing process, at least one spec data corresponding to the parameters, and the weights corresponding to the spec data as training data; batch processing the labeled training data into a learning model; testing and verifying the user recommendation data based on a ground truth set established by the user's evaluation of the recommendation data extracted based on the final data; generating feedback data based on the testing and verification; and tuning the parameters of the learning model based on the feedback data to perform supervised learning of the recommendation data for the user's final data.

In one embodiment, the step of calculating the final data based on the first motion information includes calculating the final data when the pre-stored motion information matching data matches the first motion information performed in each manufacturing process.

In one embodiment, a computer-readable storage medium stores a computer program for executing the method in conjunction with hardware.

Additionally, a computer-readable recording medium storing a computer program for implementing the present disclosure may be provided.

### BRIEF DESCRIPTION OF THE DRAWINGS

FIG. 1 is a schematic diagram of an XR-based semiconductor manufacturing process training system according to an embodiment of the present invention.

FIG. 2 is a schematic diagram of an XR-based semiconductor manufacturing process training device according to an embodiment of the present invention.

FIG. 3 is a diagram showing the configuration of the XR device shown in FIG. 2 according to an embodiment of the present invention.

FIG. 4A is a diagram for explaining an XR-based semiconductor manufacturing process training method according to an embodiment of the present invention, and FIG. 4B is a diagram for explaining an XR-based semiconductor manufacturing process training method according to an embodiment of the present invention.

FIG. 5A is a diagram showing virtual visual data stored in the memory according to an embodiment of the present invention, and FIG. 5B is an exemplary diagram for explaining the data stored in the memory according to an embodiment of the present invention.

FIG. 6 is a diagram showing the UI (User Interface) displayed on the display unit of the XR device according to an embodiment of the present invention.

FIG. 7 is a diagram showing an artificial intelligence learning system according to an embodiment of the present invention.

FIGS. 8 to 12 are exemplary diagrams for explaining some operations of the XR-based semiconductor manufacturing process training device according to an embodiment of the present invention.

FIG. 13 is a diagram for explaining the operation of the XR-based semiconductor manufacturing process training device according to an embodiment of the present invention.

### DETAILED DESCRIPTION

Hereinafter, preferred embodiments of the present disclosure will be described in detail with reference to the accompanying drawings. Advantages and features of the present invention, and methods of achieving them, will become apparent with reference to the embodiments described below in detail along with the accompanying drawings. However, the technical spirit of the present invention is not limited to the following embodiments but can be implemented in various different forms, and the following embodiments are provided to make the technical spirit of the present invention complete and to fully convey the scope of the present invention to those skilled in the technical field to which the present invention pertains. The technical spirit of the present invention is only defined by the scope of the claims.

In describing the present disclosure, detailed descriptions of related known structures or functions are omitted if it is determined that they may obscure the gist of the present invention.

Unless otherwise defined, the terms used in the following embodiments (including technical and scientific terms) can be used in meanings commonly understood by those skilled in the art to which the present disclosure belongs. However, these terms may vary depending on the intention or precedent of those skilled in the relevant field, or the emergence of new technologies. The terms used in the present disclosure are for the purpose of describing the embodiments and are not intended to limit the scope of the present disclosure.

Singular expressions used in the following embodiments include plural concepts unless they are clearly specified as singular in context. Similarly, plural expressions include singular concepts unless they are clearly specified as plural in context.

In addition, the terms first, second, A, B, (a), (b), etc. used in the following embodiments are only used to distinguish one component from another, and the nature, order, or sequence of those components are not limited by these terms.

In this specification, the term Extended Reality (XR) may be used as a comprehensive concept encompassing Virtual Reality (VR), Augmented Reality (AR), and Mixed Reality (MR). XR technology can be applied to devices such as Head-Mounted Displays (HMDs), Head-Up Displays (HUDs), mobile phones, tablet PCs, laptops, and desktops, and a device with XR technology applied may be referred to as an XR device.

Hereinafter, in this specification, it will be assumed that the learning content related to the semiconductor process is XR content, and the user terminal used by the user for learning the semiconductor process is an XR device. That is, the learning content related to the semiconductor process may be any one of AR content, VR content, and MR content, and the user terminal may be any one of an AR device, a VR device, and an MR device, depending on the type of learning content.

Hereinafter, various embodiments of the present disclosure will be described in detail with reference to the accompanying drawings.

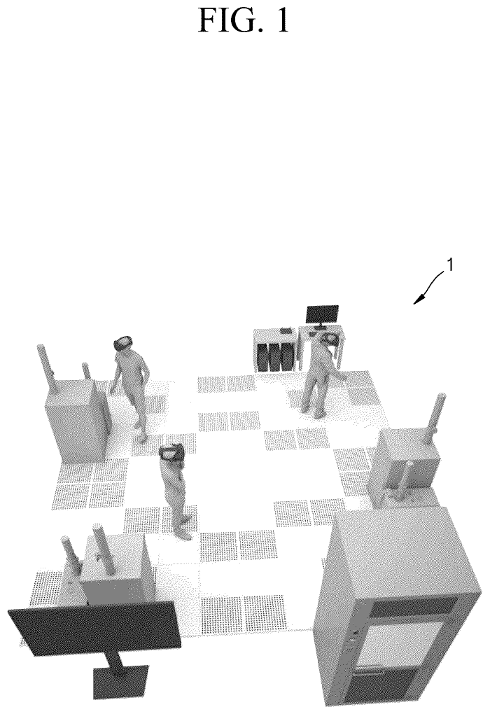

FIG. 1 is a schematic diagram of an XR-based semiconductor manufacturing process training system according to an embodiment of the present invention.

Referring to FIG. 1, at least one user can perform training on the semiconductor manufacturing process in the training space 1 while wearing XR equipment. In this case, at least one model with a size and shape similar to the equipment used in the actual semiconductor manufacturing process may be placed in the training space 1. Additionally, a virtual space (i.e., a virtual fab) where virtual semiconductor equipment is arranged may be displayed on the screen of the XR equipment worn by each user, and users can learn about the semiconductor manufacturing process through various learning content provided based on the virtual fab environment displayed on the XR equipment screen.

In this specification, the XR-based semiconductor manufacturing process training device according to the present disclosure includes all various devices that can perform computational processing and provide results to the user. For example, the XR-based semiconductor manufacturing process training device according to the present disclosure can include a computer, a server device, and a portable XR-based semiconductor manufacturing process training device, or it can be in the form of any one of these.

Here, the computer may include, for example, a laptop, desktop, slate PC, or tablet PC equipped with a web browser.

The server device, as a server that processes information by communicating with external devices, may include an application server, computing server, database server, file server, game server, mail server, proxy server, and web server.

The portable XR-based semiconductor manufacturing process training device may include, for example, any handheld wireless communication device that guarantees portability and mobility, such as a PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminal, smartphone, and so on. The portable XR-based semiconductor manufacturing process training device may also include wearable devices such as watches, rings, bracelets, anklets, necklaces, glasses, contact lenses, or head-mounted devices (HMD).

However, the actual training space where the XR-based semiconductor manufacturing process training takes place is not limited to the example illustrated in FIG. 1. For example, for safety reasons, a single user may enter the training space to learn the semiconductor manufacturing process, or the training may take place in a training space without any physical equipment. Additionally, due to constraints on the size of the space, the user's position in the training space may be fixed, and the semiconductor manufacturing process training may proceed by moving a virtual user within the virtual fab using a controller provided with the XR equipment.

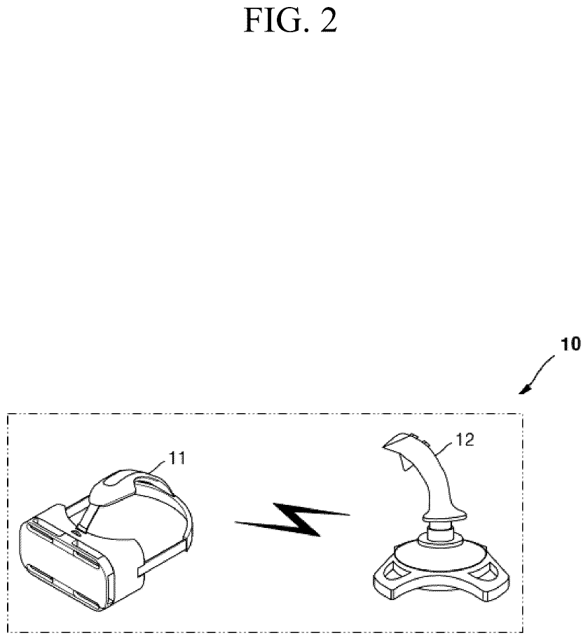

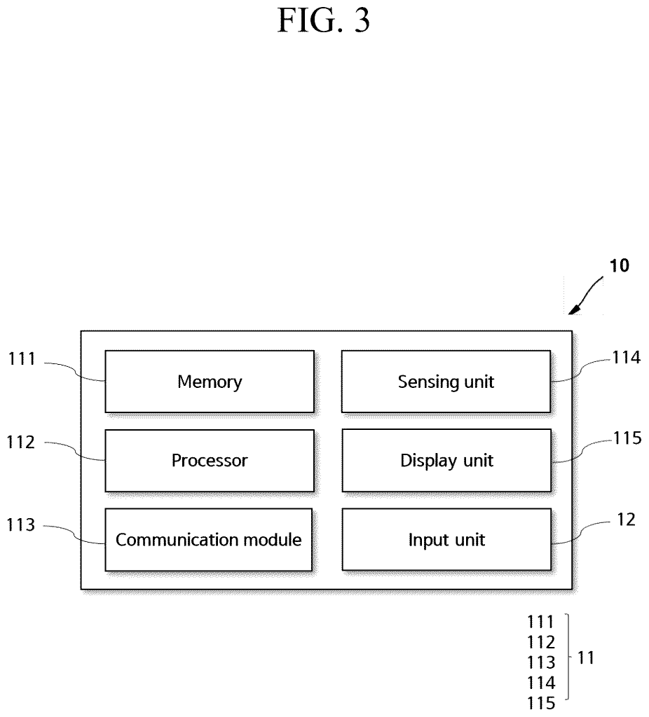

FIG. 2 is a schematic diagram of an XR-based semiconductor manufacturing process training device according to an embodiment of the present invention, and FIG. 3 is a diagram showing the configuration of the XR equipment shown in FIG. 2 according to an embodiment of the present invention.

Referring to FIG. 2, XR equipment 11 and a controller 12 may be provided to perform the operation of the present invention.

In one embodiment, the XR equipment 11 detects the movement motion of the user located inside the training space 1 using a first motion detection sensor and can move the user within the virtual fab by a distance corresponding to the detected movement motion. In this case, a user who intends to proceed with training while moving inside the virtual fab may be required to move within the training space 1. In one embodiment, the motion detection sensor may be a gyroscope-based sensor.

Additionally, the XR equipment 11 can use a second motion detection sensor, different from the first motion detection sensor, to detect the gestures of the user located inside the training space 1 and provide XR content corresponding to the detected gestures. In this case, a user who intends to perform training to control virtual semiconductor equipment inside the virtual fab may be required to perform predefined actions at specific locations within the training space 1 to control the virtual semiconductor equipment.

Meanwhile, there may be cases where it is not possible to secure a training space equivalent in size to the actual semiconductor manufacturing process space due to space constraints, or where a user with mobility issues intends to perform semiconductor manufacturing process training. Therefore, it is necessary to support the user so that they can perform XR-based semiconductor manufacturing process training without needing to move within the physical training space or perform special actions.

In one embodiment, the user can use a controller 12 that can communicate with the XR equipment to move a virtual user (e.g., user avatar, character) located in the virtual fab or to control the virtual user's actions. The controller 12, which allows the user's character in the virtual space to move in the desired direction and distance or perform predefined actions according to the user's manual operation, is well known to those skilled in the art in terms of its configuration and operation, and thus detailed descriptions will be omitted. Additionally, the XR-based semiconductor manufacturing process training device 10 can receive user input data related to the content displayed on the display unit 115 of the XR equipment 11 through the controller 12. According to this embodiment, the XR-based semiconductor manufacturing process training method can be provided regardless of the size of the training space, the user's mobility, or the ability to perform specific actions.

Meanwhile, in the semiconductor manufacturing process training course, it is also possible to selectively use either the method where the user moves directly to perform the training according to the learning mode settings for each process, or the method where the user performs the training without moving by only operating the controller 12.

Referring to FIG. 3, the XR-based semiconductor manufacturing process training device 10 may include XR equipment 11 and a controller 12. The XR equipment 11 may include a memory 111, a processor 112, a communication module 113, a sensing unit 114, and a display unit 115. Meanwhile, in this specification, the controller 12 may be referred to as the input unit 12. The memory 111 can store at least one instruction.

In one embodiment, the memory 111 can store virtual visual data, at least one specification data (spec data) corresponding to parameters defined in each manufacturing process, and weights corresponding to the spec data. The memory 111 can store data supporting various functions of the device, programs for the operation of the processor 112, and input/output data (for example, music files, still images, videos, etc.). Additionally, the memory 111 can store multiple application programs running on the device, as well as data and instructions for the operation of the device. At least some of these application programs can be downloaded from an external server via wireless communication.

The memory 111 can include at least one type of storage medium, such as flash memory type, hard disk type, SSD type (Solid State Disk type), SDD type (Silicon Disk Drive type), multimedia card micro type, card type memory (e.g., SD or XD memory), RAM (random access memory), SRAM (static random access memory), ROM (read-only memory), EEPROM (electrically erasable programmable read-only memory), PROM (programmable read-only memory), magnetic memory, magnetic disk, and optical disk. Additionally, the memory 111 may be a database that is separate from the system but connected via wired or wireless communication.

The processor 112 can communicate with the memory 111 to execute at least one instruction stored in the memory 111.

The control unit of this device can be implemented with a memory 111 that stores data for an algorithm or a program reproducing the algorithm to control the operation of components within the device, and at least one processor 112 that communicates with the memory 111 to perform the aforementioned operations using the data stored in the memory. In this case, the memory 111 and the processor 112 can be implemented as separate chips, or the memory 111 and the processor 112 can be implemented as a single chip.

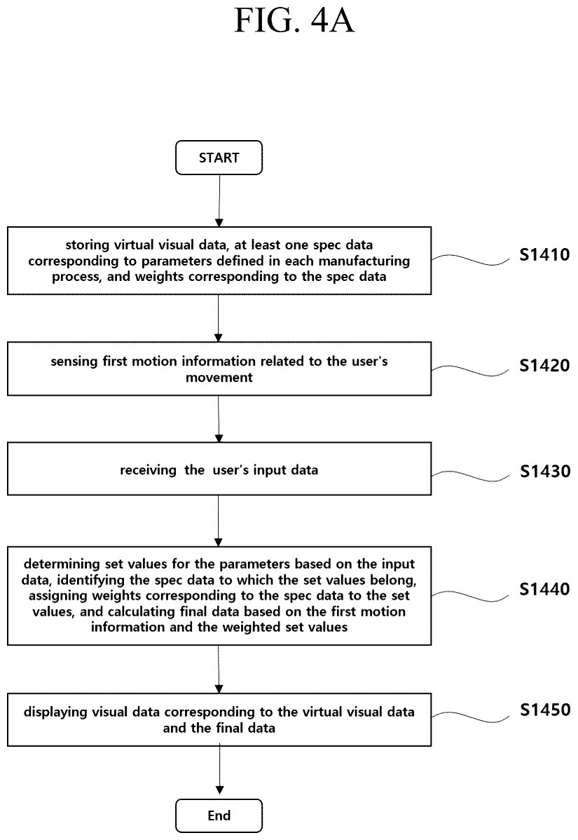

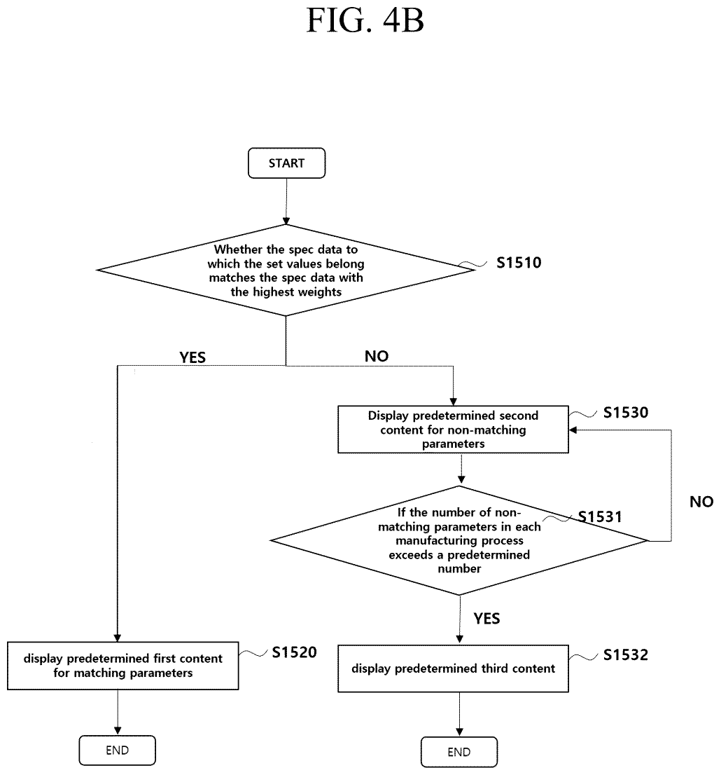

Additionally, the processor 112 can control any one or a combination of the components described above to implement various embodiments according to the present disclosure, as described in FIGS. 4A to 13, on the device.

Among the components, the communication module 113 can include one or more components that enable communication between the XR equipment 11 and the controller 12, as well as communication between multiple XR equipments 11. For example, the communication module 113 can include at least one of a broadcast reception module, a wired communication module, a wireless communication module, a short-range communication module, and a location information module.

The wireless communication module can include a wireless communication module that supports various wireless communication methods such as WiFi modules, Wireless Broadband (WiBro) modules, GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long Term Evolution), 4G, 5G, and 6G.

The wireless communication module can include a wireless communication interface comprising an antenna and a transmitter for transmitting mobile communication signals. Additionally, the wireless communication module can further include a mobile communication signal conversion module that modulates digital control signals output from the control unit into analog wireless signals through the wireless communication interface under the control of the control unit.

The wireless communication module can include a wireless communication interface comprising an antenna and a receiver for receiving mobile communication signals. Additionally, the wireless communication module can further include a mobile communication signal conversion module that demodulates analog wireless signals received through the wireless communication interface into digital control signals.

The location information module is a module for obtaining the location (or current location) of the XR equipment 11 in this disclosure. Representative examples include a GPS (Global Positioning System) module or a WiFi (Wireless Fidelity) module. For example, using a GPS module, the location of the user wearing the XR equipment 11 can be obtained by utilizing signals sent from GPS satellites. As another example, using a WiFi module, the location of the user wearing the XR equipment 11 can be obtained based on information from a wireless AP (Wireless Access Point) that transmits or receives wireless signals with the WiFi module. If necessary, the location information module can perform any function of other modules of the communication unit to obtain data regarding the location of an unmanned vehicle, either as a replacement or additionally. The location information module is used to obtain the location (or current location) of the user wearing the XR equipment 11, and it is not limited to modules that directly calculate or obtain the location of the user wearing the XR equipment 11.

The sensing unit 114 senses at least one of internal information of the device, surrounding environment information, and user information, and generates corresponding sensing signals. In one embodiment, user information can refer to the user's motion information. The processor 112 can control the operation or function of the device based on these sensing signals, or perform data processing, functions, or operations related to applications installed on the device.

The sensing unit 114 can include at least one of a proximity sensor, illumination sensor, touch sensor, acceleration sensor, magnetic sensor, gravity sensor (G-sensor), gyroscope sensor, motion sensor, RGB sensor, infrared sensor (IR sensor), finger scan sensor, ultrasonic sensor, optical sensor (e.g., camera), microphone, environmental sensors (e.g., barometer, hygrometer, thermometer, radiation detection sensor, thermal sensor, gas detection sensor), and chemical sensors (e.g., healthcare sensors, biometric sensors). Additionally, the device can utilize a combination of information sensed by at least two or more of these sensors. In one embodiment, the first motion detection sensor senses the user's movement information, and the second motion detection sensor senses the user's gestures. The processor 112 can perform operations by combining the information sensed by the first motion detection sensor and the second motion detection sensor.

The display unit 115 displays (outputs) information processed by the device and visual data stored in the memory. For example, the display unit 115 can display execution screen information of applications (e.g., applications) running on the device, or UI (User Interface) and GUI (Graphic User Interface) information according to the execution screen information.

The input unit 12 is for inputting visual information (or signals), audio information (or signals), data, or information input by the user, and can include at least one camera, at least one microphone, and at least one user input unit. The voice data or image data collected by the input unit 12 can be analyzed and processed as control commands from the user.

In one embodiment, the camera processes image frames such as still images or videos obtained by the image sensor in shooting mode. The processed image frames can be displayed on the display unit 115 (or the screen of the XR-based semiconductor manufacturing process training device of the present disclosure) or stored in the memory 111. According to one embodiment of the present invention, the camera sensor may be an AI-based vision camera sensor. Based on the operation of the vision camera, data regarding specific body parts of the user can be used as training data for supervised learning. Consequently, the vision camera sensor can accurately recognize specific body parts and gestures of those parts, thereby acquiring sensing information.

Meanwhile, if there are multiple cameras, they can be arranged in a matrix structure. In this way, multiple image information with various angles or focuses can be input through the cameras arranged in the matrix structure. Additionally, the cameras can be arranged in a stereo structure to acquire left and right images for implementing 3D stereoscopic images.

In another embodiment, the microphone processes external sound signals into electrical voice data. The processed voice data can be utilized in various ways depending on the function being performed by the device (or the application being executed). Additionally, the microphone can implement various noise reduction algorithms to eliminate noise generated during the process of receiving external sound signals.

The user input unit is for receiving information from the user, and when information is input through the user input unit, the processor 112 can control the operation of the device to correspond to the inputted information. In one embodiment, the user input unit can be the controller 12. The user input unit can include hardware physical keys (for example, buttons located on at least one of the front, back, or sides of the device, dome switches, jog wheels, jog switches, etc.) and software touch keys. For example, the touch key can be a virtual key, soft key, or visual key displayed on the touchscreen type display unit through software processing, or it can be a touch key placed on a part other than the touchscreen. The virtual or visual key can be displayed on the touchscreen in various forms, such as graphics, text, icons, videos, or combinations thereof.

At least one component may be added or deleted in response to the performance of the components shown in FIG. 3. Additionally, the relative positions of the components can be changed in response to the performance or structure of the system, which will be readily understood by those skilled in the art.

Meanwhile, each component shown in FIG. 3 refers to software and/or hardware components such as Field Programmable Gate Arrays (FPGA) and Application Specific Integrated Circuits (ASIC).

FIG. 4A is a diagram for explaining an XR-based semiconductor manufacturing process training method according to an embodiment of the present invention, and FIG. 4B is a diagram for explaining an XR-based semiconductor manufacturing process training method according to an embodiment of the present invention.

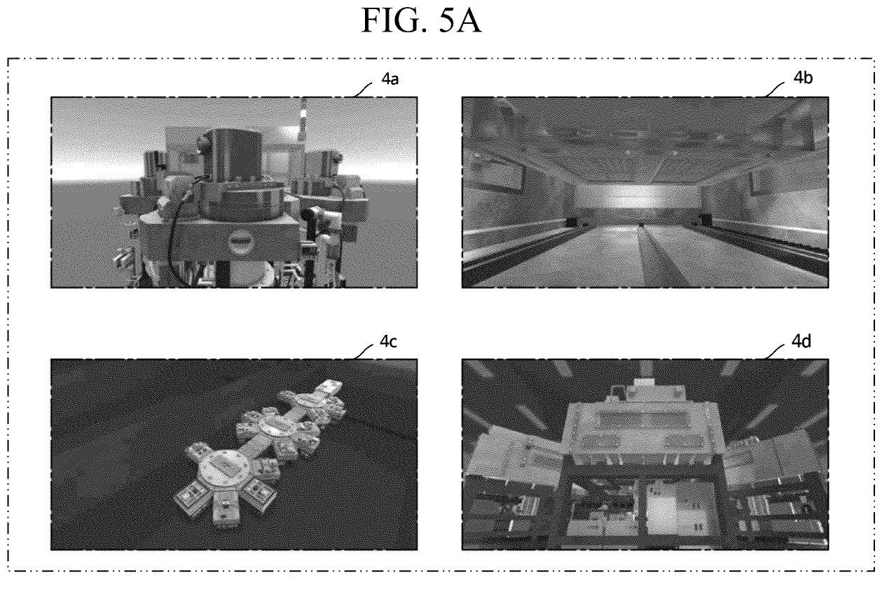

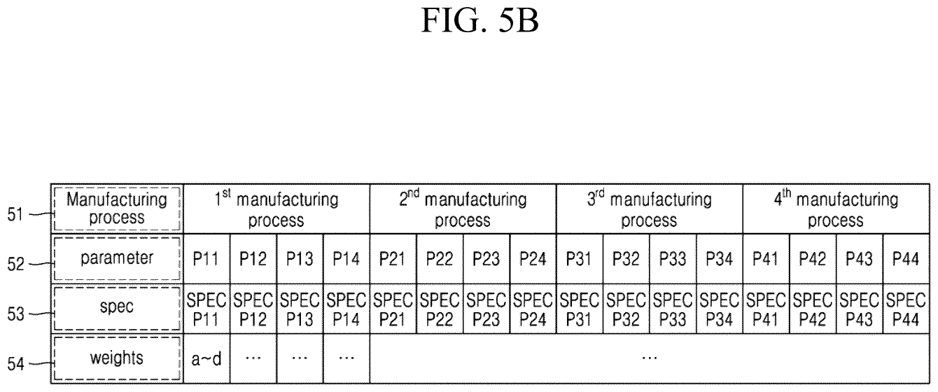

Referring to FIGS. 4A and 4B, the XR-based semiconductor manufacturing process training device 10 can provide a semiconductor manufacturing process training method using the XR equipment 11 and the controller 12.
S1410, as shown in FIG. 5B, can be a step of storing virtual visual data, at least one spec data corresponding to parameters defined in each manufacturing process, and weights corresponding to the spec data in the memory. In one embodiment, a plurality of data can be stored in the memory 111 in a lookup table format.
S1420 can be a step of sensing first motion information related to the user's movement by the sensing unit 114. In one embodiment, the first motion information can refer to information about the user's movement. That is, the XR-based semiconductor manufacturing process training device 10 can sense the user's movement through the first motion detection sensor.
S1430 can be a step of receiving user input data by the input unit 12 (controller). In one embodiment, the user input data can include process information selected by the user among the manufacturing processes and spec setting information related to the parameters.
S1440 can be a step in which the processor 112 determines the set values for the parameters based on the input data, identifies the spec data to which the set values belong, assigns weights corresponding to the spec data to the set values, and calculates the final data based on the first motion information and the weighted set values. That is, the processor 112 determines the set values according to the user's input data, identifies the spec range to which the set values belong, and assigns weights stored in the memory to the corresponding spec range, thereby assigning weights to the user's input data. The processor 112 can calculate the user's final data based on the first motion information and the weighted set values.
S1450 can be a step of displaying visual data corresponding to the virtual visual data and the final data. The visual data corresponding to the virtual visual data and the final data can be displayed on the display unit 115 as shown in FIG. 5A.

Referring to FIG. 4B, S1510 can be a step in which the processor 112 determines whether the spec data to which the set values belong matches the spec data with the highest weight. If the processor 112 determines that the spec data to which the set values belong matches the spec data with the highest weight, the display unit 115 can display predetermined first content for the matching parameters S1520. For example, if the user inputs a set value that corresponds to the spec range with the highest weight for the temperature parameter in the first manufacturing process, first content corresponding to “correct” can be displayed. Conversely, if the processor 112 determines that the spec data to which the set values belong does not match the spec data with the highest weight, the display unit 115 can display predetermined second content for the non-matching parameters S1530. For example, if the user does not input a set value that corresponds to the spec range with the highest weight for the temperature parameter in the first manufacturing process, second content corresponding to “incorrect” can be displayed. In this case, the processor 112 can further determine whether the number of non-matching parameters in each manufacturing process exceeds a predetermined number S1531. If the processor 112 determines that the number of non-matching parameters in each manufacturing process exceeds the predetermined number, the display unit 115 can display predetermined third content S1532. For example, if the user inputs set values corresponding to “incorrect” three or more times, third content corresponding to “failure”can be displayed.

FIG. 5A is a diagram showing virtual visual data stored in the memory according to an embodiment of the present invention, and FIG. 5B is an exemplary diagram for explaining data stored in the memory according to an embodiment of the present invention.

As shown in FIG. 5A, in response to the user being positioned in an area adjacent to the first virtual semiconductor equipment placed in the virtual fab, multiple auxiliary components located outside the first virtual semiconductor equipment can be displayed on the screen. At this time, the first motion detection sensor included in the sensing unit 114 of the XR-based semiconductor manufacturing process training device 10 can sense the user's movement within the training space 1 shown in FIG. 1, and based on the sensed data, determine whether the user is positioned in an area adjacent to the first virtual semiconductor equipment placed in the virtual fab.

Additionally, as described above with reference to FIG. 1, in response to receiving a controller operation input for the first virtual semiconductor equipment from a user located at a distance from the first virtual semiconductor equipment, multiple auxiliary components located outside the first virtual semiconductor equipment can be displayed on the screen. In this case, the controller operation input can include various input methods such as a specific operation button input for the first virtual semiconductor equipment, a pointer input for the first virtual semiconductor equipment for a certain period of time, and a zoom-in input for the first virtual semiconductor equipment.

Meanwhile, as the user performs XR-based semiconductor process learning, the user can change the display mode shown on the output unit of the user terminal. In this case, the display mode can be changed by predefined user gestures (e.g., touch on the side of the user terminal) or by the user's selection input on a specific button displayed on the control screen.

As illustrated in 4b to 4d of FIG. 5A, depending on the user's change in display mode, the user terminal can display a screen in the first mode 4b where the interior of the virtual semiconductor equipment can be viewed, a screen in the second mode 4c where all virtual semiconductor equipment placed in the virtual fab can be viewed, and a screen in the third mode 4d where virtual semiconductor equipment having a size similar to that of the actual semiconductor equipment can be viewed at actual size.

Specifically, the screen in the first mode 4b may be the most suitable for the user to learn about some key processes occurring inside the virtual semiconductor equipment. Additionally, the screen in the second mode 4c may be the most suitable for the user to understand where the current process being learned fits within the overall process or to learn the progress of multiple processes being conducted simultaneously. Furthermore, the screen in the third mode 4d may be the most suitable for the user to learn about the shapes or arrangement of equipment used in actual semiconductor processes, as well as the movement patterns of engineers during the actual semiconductor process.

Thus, by selecting the most suitable screen mode for each process, the user can perform process learning more efficiently, and the learner's achievement can be effectively improved. Additionally, by selecting the screen mode according to the user's needs, the user's learning interest and engagement can be increased.

Referring to FIG. 5B, in addition to the virtual visual data, the memory 111 can store at least one spec data 53 corresponding to parameters 52 defined in each manufacturing process 51 and weights 54 corresponding to the spec data. Hereinafter, for the convenience of explanation, the spec of parameter P11 of the first manufacturing process in FIG. 5B will be described in detail.

For example, in semiconductor manufacturing process training, the processes of the first manufacturing process, second manufacturing process, third manufacturing process, and fourth manufacturing process can be conducted. The manufacturing processes can include, for instance, the eight major semiconductor manufacturing processes: fabricating wafer, oxidation, photolithography, etching, thin film deposition, metal wiring, EDS, and packaging.

The first manufacturing process can include parameters 52 such as P11 to P14. The second manufacturing process can include parameters 52 such as P21 to P24. The third manufacturing process can include parameters 52 such as P31 to P34. The fourth manufacturing process can include parameters 52 such as P41 to P44. Parameters 52 can refer to factors set during the manufacturing process, such as temperature, density, pressure, and composition ratio.

Spec data 53 can be defined for each parameter 52, and each spec data 53 can have different weights 54. For example, parameter P11 can be matched with SPECP11, which includes multiple spec ranges, and stored in the memory 111. If P11 represents temperature, SPECP11 can be defined as follows: 30° C.˜40° C. is the first spec, 40° C.˜50° C. is the second spec, below 30° C. is the third spec, and above 50° C. is the fourth spec. In this case, a weight “a” can be assigned to the first spec, a weight “b” to the second spec, a weight “c” to the third spec, and a weight “d” to the fourth spec. If the weights are such that “b”>“a”>“c”>“d”, then in the first manufacturing process, the optimal spec range for parameter P11 can be defined as the second spec range (40° C.˜50° C.) with the highest weight, followed by the first spec range (30° C.˜40° C.), the third spec range (below 30° C.), and the least optimal spec range can be defined as the fourth spec range (above 50° C.).

Thus, there can be various parameters 52 for each manufacturing process 51, and for each parameter 52, there can be various spec datas 53. Each spec data 53 can have a different weight 54 assigned and stored in the memory 111.

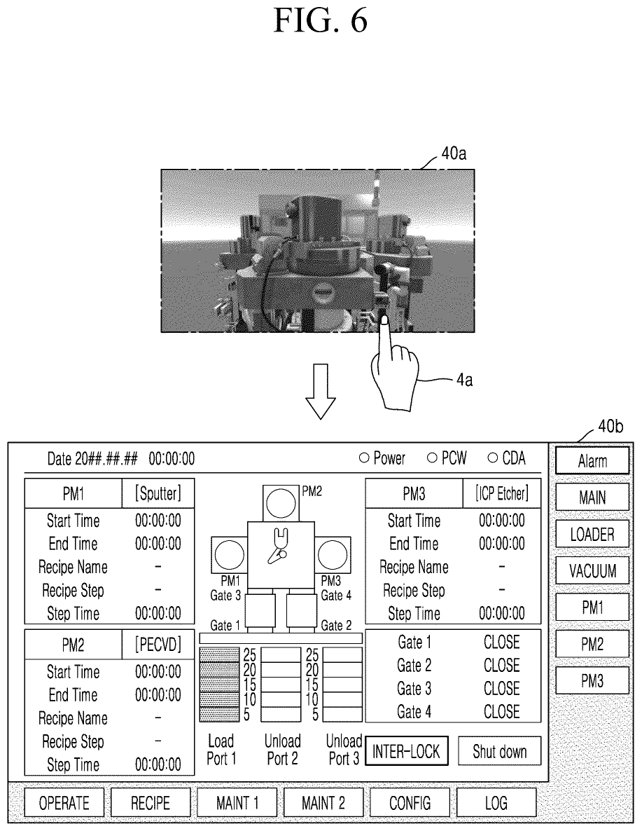

FIG. 6 is a diagram showing the UI (User Interface) displayed on the display unit of the XR equipment according to an embodiment of the present invention.

Referring to FIG. 6, in response to a user's predefined gesture toward the virtual semiconductor equipment placed in the virtual fab, a control screen displaying status information of the virtual semiconductor equipment can be displayed on the display unit of the virtual semiconductor equipment.

As shown in FIG. 6, in response to the user's first gesture (e.g., selection input 4a) toward a specific part or area (e.g., the monitor of the first virtual semiconductor equipment) on the screen 40a where the first virtual semiconductor equipment is displayed, the first control screen 40b displaying status information of the first virtual semiconductor equipment can be displayed on the display unit 115 of the XR equipment. At this time, as previously mentioned, the predefined first gesture toward the first virtual semiconductor equipment can be received from the user regardless of whether the user is located in an area adjacent to the first virtual semiconductor equipment. Additionally, the first gesture can be variously defined according to the settings of the service provider or administrator and the user's learning mode settings.

For example, the first gesture can include the action which a user entering the virtual training space (i.e., fab) moves to an area adjacent to the first virtual semiconductor equipment, and the action of the user touching the monitor component of the first virtual semiconductor equipment in the adjacent area.

Additionally, the first gesture can include the action of the user selecting the first virtual semiconductor equipment using the operation button of the controller (e.g., pressing the equipment selection button on the controller, selecting the item UI corresponding to the first virtual semiconductor equipment, or selecting the first virtual semiconductor equipment).

Furthermore, the first gesture can include the action of the user being located in an area adjacent to the first virtual semiconductor equipment for a time exceeding a certain threshold or maintaining a pointing input toward the first virtual semiconductor equipment for a time exceeding a certain threshold, without pressing any operation button on the controller 12 of the XR-based semiconductor manufacturing process training device 10 or any specific button displayed on the display unit.

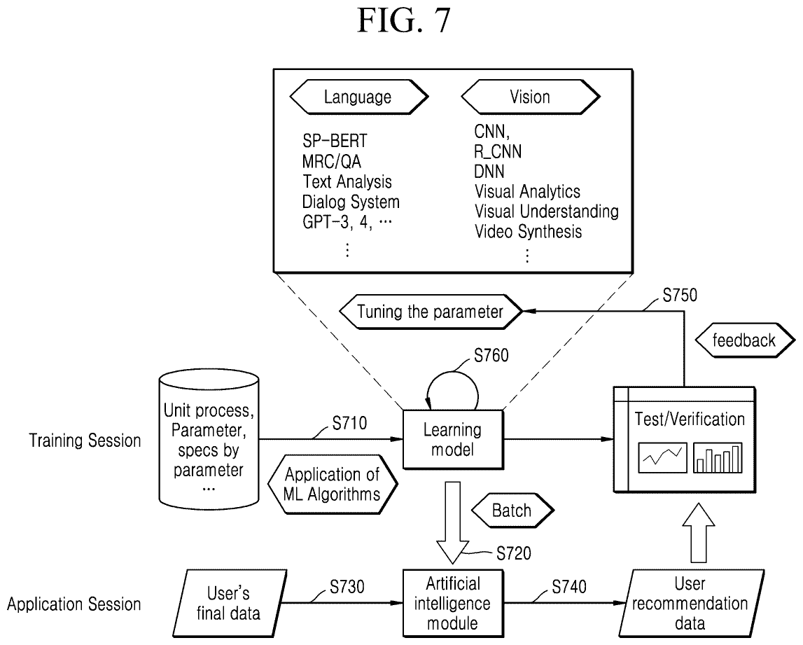

FIG. 7 is a diagram showing an artificial intelligence learning system according to an embodiment of the present invention.

Referring to FIG. 7, S710 can be a step of labeling by using each manufacturing process, the parameters defined in each manufacturing process, at least one spec data corresponding to the parameters, and the weights corresponding to the spec data as training data. In other words, it can be a step of labeling by matching various data stored in the memory 111 as training data. S720 can be a step of batch processing the labeled training data into the learning model. S730 can be a step in which the artificial intelligence module receives the user's final data. That is, as described above with reference to FIG. 4, when the final data is calculated based on the first motion information and the weighted set values, it refers to the step where the artificial intelligence module receives the user's final data as input. S740 can be a step in which the artificial intelligence module outputs user recommendation data when the user's final data is entered as input data. In one embodiment, the user recommendation data can include the manufacturing process that the user needs to supplement while performing the training course, and the spec data with the highest weights for the parameters. S750 can be a step of testing and verifying the user recommendation data based on the ground truth set. The ground truth set can be established based on the user's evaluation of the user recommendation data or can be pre-stored in the memory. S760 can be a step of tuning the parameters of the learning model based on the feedback data to perform supervised learning of the user recommendation data for the user's final data.

Meanwhile, the learning model can include at least one algorithm from Convolutional Neural Network (CNN), Random Forest (RF), Support Vector Machine (SVM), eXtreme Gradient Boosting (XGB), Decision Tree (DT), K-nearest Neighbors (KNN), Gaussian Naive Bayes (GNB), Stochastic Gradient Descent (SGD), Linear Discriminant Analysis (LDA), Ridge, Lasso, and Elastic Net.

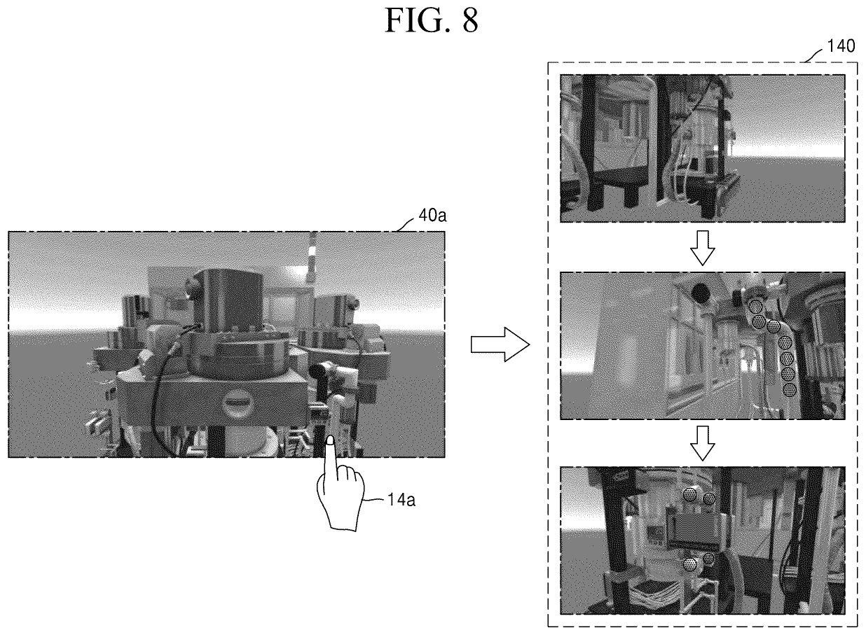

FIGS. 8 to 12 are exemplary diagrams for explaining some operations of the XR-based semiconductor manufacturing process training device according to an embodiment of the present invention.

Referring to FIG. 8, it can be an example of a method for the user to learn the flow of fluid passing through one or more virtual semiconductor equipment.

In one embodiment, the first learning content for the first process being conducted inside the first virtual semiconductor equipment can include an animation depicting the flow of fluid passing through the first virtual semiconductor equipment. At this time, the flow of the fluid can include information on at least one of the particle size, shape, color, and movement speed of the fluid. Additionally, the fluid can refer to any one of liquid, gas, and plasma, and it can also be a mixture of multiple fluids, gases, or plasma. For the convenience of explanation, the following description in this specification will focus on the case where the fluid is gas.

As shown in FIG. 8, in response to a user's selection input (e.g., touch input 14a) on the screen 40a displaying the first virtual semiconductor equipment, a first animation 140 depicting the flow of fluid passing through the first virtual semiconductor equipment can be displayed on the output unit of the XR equipment. For example, the first animation 140 can be a simulation video depicting the flow of gas discharged from the first sub-virtual semiconductor equipment moving to the second sub-virtual semiconductor equipment through a gas pipe.

At this time, the particle size, shape, and color of the gas can be represented differently depending on the type of gas. The gas can correspond to a recipe set by the user. Therefore, if the user changes the recipe, the visual representation of the gas can change accordingly. For example, the color corresponding to gas A can be blue, and the color corresponding to gas B can be green. If the user changes the recipe so that the gas passing through the virtual semiconductor equipment changes from gas A to gas B, the flow of gas can be displayed in green, corresponding to gas B.

In one embodiment, if the user performs an operation (e.g., changing the recipe) to increase the concentration of a specific gas during the process, the color corresponding to the gas with increased concentration can be more prominently displayed inside the virtual semiconductor equipment. That is, depending on the user's operation, the saturation or brightness of a specific color can increase or decrease.

However, the method of depicting the flow of fluid is not limited to the example shown in FIG. 8, and the flow of fluid can be represented in various ways depending on the service provider or user settings. Additionally, the animation depicting the flow of fluid can vary for each process.

In one embodiment, the first learning content for the first process can include an animation where the first virtual semiconductor equipment becomes transparent in response to the fluid used in the first process entering from outside to inside the first virtual semiconductor equipment. That is, even if the user does not input a specific gesture toward the first virtual semiconductor equipment, the virtual semiconductor equipment can automatically become transparent at the point when the fluid enters the virtual semiconductor equipment during the fluid flow process. According to this embodiment, user convenience can be enhanced by minimizing user operations during the learning process.

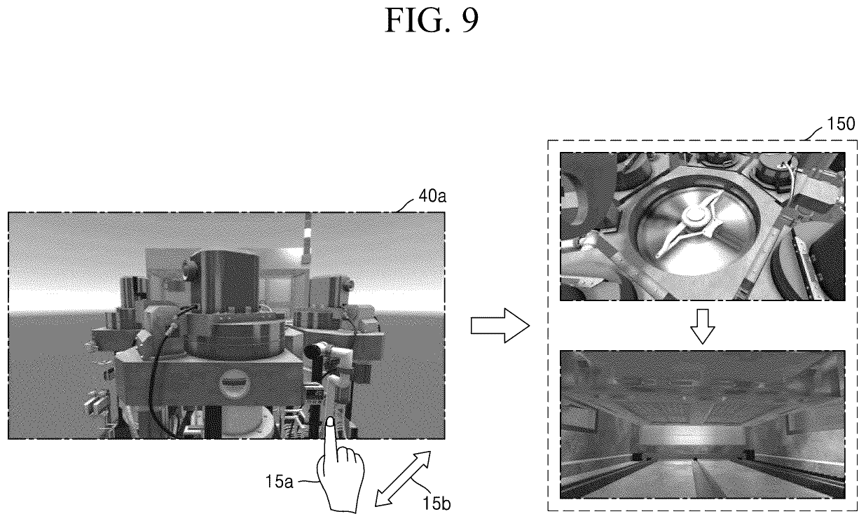

Referring to FIG. 9, it can be an example of a method for the user to learn about the auxiliary components (e.g., internally assembled components) that make up the virtual semiconductor equipment.

In one embodiment, the first learning content for the first process taking place inside the first virtual semiconductor equipment can include information about the auxiliary components that make up the first virtual semiconductor equipment where the first process is performed.

As shown in FIG. 9, in response to the user's gesture (e.g., pinch gesture 15a, 15b) on the screen 40a displaying the first virtual semiconductor equipment, a second animation 150 depicting information about the auxiliary components that make up the first virtual semiconductor equipment can be displayed on the output unit of the XR equipment. For example, the second animation 150 can be a simulation video that sequentially enlarges and displays the multiple auxiliary components arranged inside the first virtual semiconductor equipment in a predetermined order. At this time, the predetermined order can correspond to the order of the auxiliary components arranged along the path through which the gas flows within the first virtual semiconductor equipment.

Meanwhile, the method of depicting information about the multiple auxiliary components that make up the first virtual semiconductor equipment is not limited to the example shown in FIG. 9, and the information about the multiple auxiliary components that make up the first virtual semiconductor equipment can be represented in various ways depending on the service provider or user settings. Additionally, the animation depicting information about the auxiliary components that make up the virtual semiconductor equipment can vary for each process.

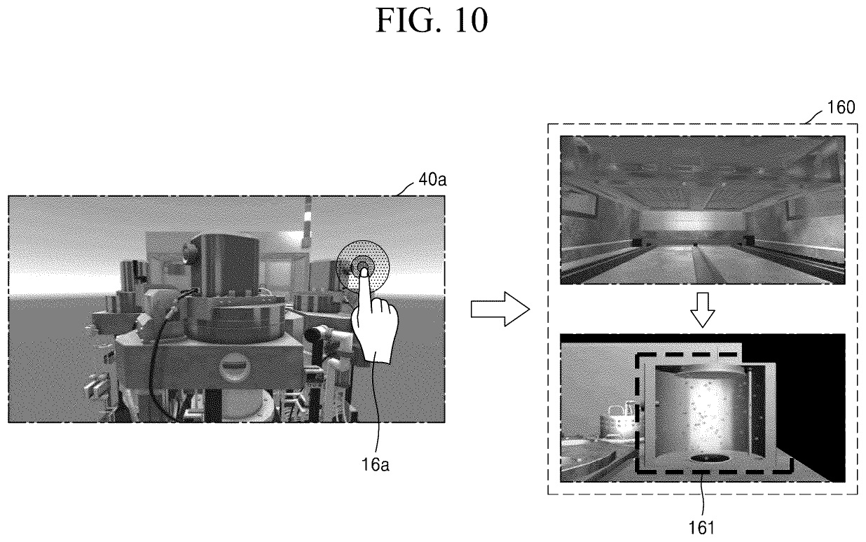

Referring to FIG. 10, it can be an example of a method for the user to learn about the processes taking place inside the virtual semiconductor equipment. These processes can include an etching process that creates patterns forming the semiconductor structure inside the virtual semiconductor equipment under high temperature and high pressure conditions, a deposition process that creates thin films that serve to separate and connect circuits, and an ion implantation process that gives the semiconductor its electrical properties. However, these processes are not limited to the etching process, deposition process, and ion implantation process. The processes can include all processes that can be used in the semiconductor manufacturing process.

As shown in FIG. 10, in response to the user's gesture (e.g., long tap input 16a) on the screen 40a displaying the first virtual semiconductor equipment, a third animation 160 depicting the process taking place inside the first virtual semiconductor equipment can be displayed on the output unit of the XR equipment. For example, the third animation 160 can be a simulation video representing the etching process, deposition process, or ion implantation process occurring inside the first virtual semiconductor equipment.

Furthermore, the third animation 160 shown in FIG. 10 can include a simulation video depicting the gas flow within the virtual semiconductor equipment and the process of the gas contacting the wafer inside the virtual semiconductor equipment, as described with reference to FIG. 8. As explained with reference to FIG. 8, the particle size, shape, color, and movement speed of each gas introduced into the virtual semiconductor equipment can be represented differently depending on the type of gas, and the graphical objects or videos depicting the gas flow can be displayed differently according to the user's set recipe. For example, the third animation 160 shown in FIG. 10 can include a fourth animation 161 depicting a plasma gas introduced into the virtual semiconductor equipment.

Additionally, if the user performs an operation (e.g., changing the recipe) to increase the concentration of a specific gas, the color corresponding to the gas with increased concentration can be more prominently displayed inside the virtual semiconductor equipment. That is, depending on the user's operation, the saturation or brightness of a specific color corresponding to the graphic object representing the gas inside the virtual semiconductor equipment can increase or decrease.

In one embodiment, if there are competing gases during the deposition or etching process, the colors of these competing gases can be displayed in complementary colors.

Meanwhile, the method of depicting the gas flow and the process of the gas contacting the wafer is not limited to the example shown in FIG. 10, and can be represented in various ways depending on the service provider or user settings. Additionally, the animation depicting the processes occurring inside the virtual semiconductor equipment can vary for each process.

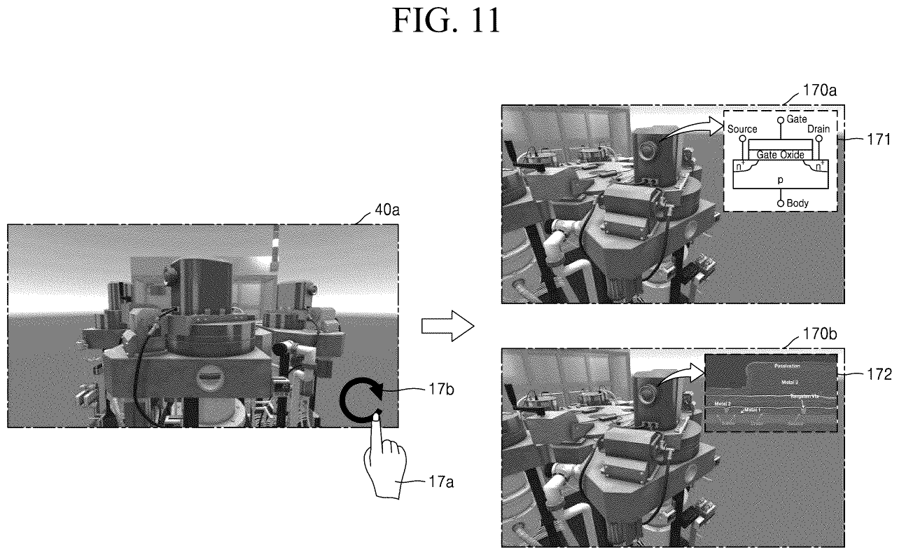

Referring to FIG. 11, it can be an example of a method for the user to learn about the results of the process conducted inside the virtual semiconductor equipment.

In one embodiment, the first learning content for the first process taking place inside the first virtual semiconductor equipment can include an image depicting the state information of the wafer produced as a result of the completion of the first process. This image can include at least one of a cross-sectional view, a perspective view, an SEM image, and a TEM image of the wafer.

As shown in FIG. 11, in response to the user's gesture (e.g., touch input 17a and clockwise drag input 17b) on the screen 40a displaying the first virtual semiconductor equipment, result images 170a and 170b depicting the information about the outcome of the first process 171 and 172 conducted inside the first virtual semiconductor equipment (i.e., the wafer) can be displayed on the output unit of the XR equipment. At this time, the result images 170a and 170b, which show the state of the wafer after the first process is completed, can be displayed in an area adjacent to the first virtual semiconductor equipment. Additionally, the state of the wafer after the completion of the first process can be represented as a cross-sectional view, perspective view, SEM image, or TEM image according to the user's settings.

Meanwhile, the image depicting the state information of the wafer produced as a result of the completion of the first process inside the first virtual semiconductor equipment is not limited to the example shown in FIG. 11, and can be represented in various ways depending on the service provider or user settings. Additionally, the image depicting the state information of the wafer can be displayed in a manner that allows the user to best understand the results of the process, depending on the type of process performed.

According to this embodiment, the user can easily and immediately understand the state information of the wafer after the process has been performed, thereby enhancing user convenience and satisfaction. Additionally, if the result is not satisfactory, the user can change the recipe to regenerate and review the results of the process, thus improving the user's learning achievement.

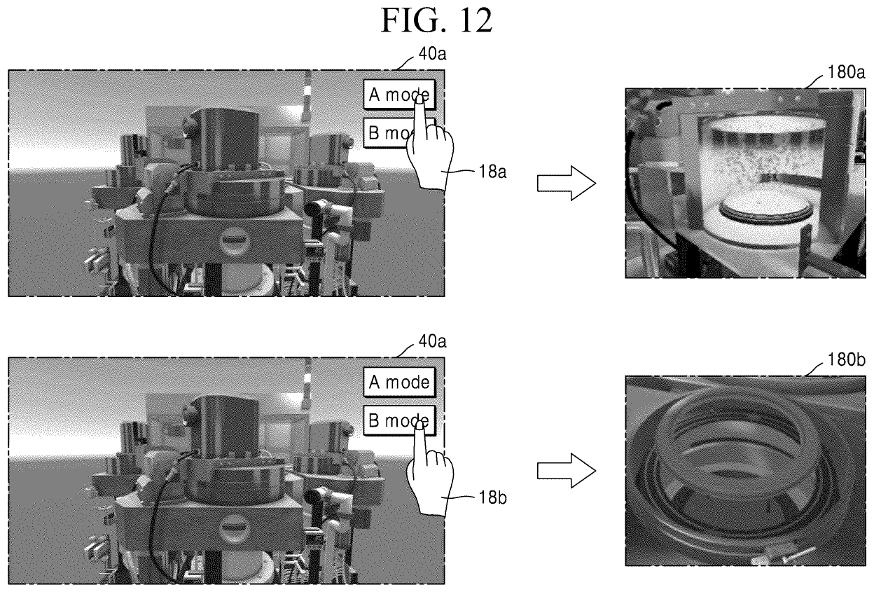

Referring to FIG. 12, it can be an example of a method for the user to set the learning mode for the processes taking place inside the virtual semiconductor equipment.

As shown in FIG. 12, graphic objects (“A mode”, “B mode”) for selecting the learning mode can be displayed on the screen 40a showing the first virtual semiconductor equipment, and the user can select one of these graphic objects to set the learning mode for the processes taking place inside the first virtual semiconductor equipment.

First, in response to the user's touch input 18a on the graphic object for “A mode”, an animation 180a depicting the process taking place inside the first virtual semiconductor equipment can be displayed on the output unit of the XR equipment.

Next, in response to the user's touch input 18b on the graphic object for “B mode”, an animation 180b depicting information about the auxiliary components that make up the first virtual semiconductor equipment can be displayed on the output unit of the XR equipment.

According to this embodiment, since the user can set the learning mode for each process, the user's needs in the learning process can be sufficiently met, and the user's learning engagement and interest can be enhanced.

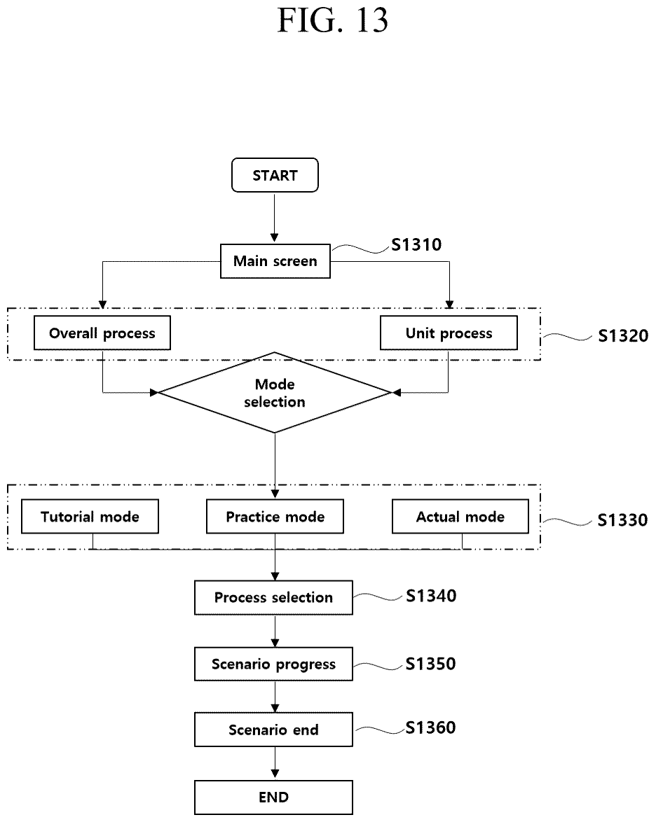

FIG. 13 is a diagram for explaining the operation of the XR-based semiconductor manufacturing process training device according to an embodiment of the present invention.

Referring to FIG. 13, the XR-based semiconductor manufacturing process training device 10 can provide educational content according to the following steps: main screen selection process S1310, selection process of the overall process or unit process S1320, mode selection process among tutorial mode, practice mode, and actual mode S1330, selection process of the process to be trained among multiple semiconductor manufacturing processes S1340, scenario progress process where the content is performed S1350, and scenario end process where the final data is generated S1360.

According to the problem-solving means of the present disclosure, it is possible to enhance the immersion and efficiency of training, enabling rapid acquisition and updating of skills. Additionally, the present invention can reduce training costs and allow for quick updates to training content in response to process changes, thereby contributing to the advancement of the semiconductor industry.

The effects of the present disclosure are not limited to the effects mentioned above, and other effects not mentioned will be clearly understood by those skilled in the art from the following description.

The steps of the methods or algorithms described in connection with the embodiments of the present invention can be implemented directly in hardware, in a software module executed by hardware, or in a combination thereof. The software module can reside in RAM (Random Access Memory), ROM (Read Only Memory), EPROM (Erasable Programmable ROM), EEPROM (Electrically Erasable Programmable ROM), flash memory, hard disk, removable disk, CD-ROM, or any form of computer-readable storage medium well known in the art.

Although the embodiments of the present invention have been described with reference to the accompanying drawings, it will be understood by those of ordinary skill in the art that the present invention can be embodied in other specific forms without changing the technical spirit or essential characteristics thereof. Therefore, the above-described embodiments should be considered in all respects as illustrative rather than restrictive.

What is claimed is:

1. An XR-based semiconductor manufacturing process training device comprising:
a memory configured to store virtual visual data, at least one spec data corresponding to parameters defined in each manufacturing process, and weights corresponding to the spec data;
a first sensor configured to sense first motion information regarding movement of user;
an input unit configured to receive input data from the user;
a processor configured to determine set values for the parameters based on the input data, identify the spec data to which the set values belong, assign weights corresponding to the spec data to the set values, and calculate final data based on the first motion information and the weighted set values; and
a display unit configured to display visual data corresponding to the virtual visual data and the final data.

2. The device of claim 1, wherein the virtual visual data includes 3D animation data.

3. The device of claim 1, wherein the input data includes process information selected by the user among the manufacturing processes and spec setting information related to the parameters.

4. The device of claim 2, wherein the processor is configured to determine whether the spec data to which the set values belong matches the spec data with highest weights.

5. The device of claim 4, wherein the display unit is configured to:
display predetermined first content for matching parameters if the spec data to which the set values belong matches the spec data with the highest weights, and
display predetermined second content for non-matching parameters if the spec data to which the set values belong does not match the spec data with the highest weights.

6. The device of claim 3, wherein the display unit is configured to display predetermined third content if the number of non-matching parameters in each manufacturing process exceeds a predetermined number.

7. The device of claim 6, wherein the processor is further configured to generate user recommendation data that includes the spec data with highest weight assigned to the parameter for which predetermined second content or the predetermined third content is displayed.

8. The device of claim 6, wherein:
each manufacturing process, the parameters defined in each manufacturing process, at least one spec data corresponding to the parameters, and the weights corresponding to the spec data are labeled as training data;
the labeled training data is batch processed into a learning model;
when user recommendation data is extracted by receiving the final data, the user recommendation data is tested and verified based on a ground truth set established by the user's evaluation of the user recommendation data;
feedback data is generated based on the testing and verification; and
the parameters of the learning model are tuned based on the feedback data to perform supervised learning of the user recommendation data for the user's final data.

9. The device of claim 3, wherein the first sensor is a gyroscope-based sensor.

10. The device of claim 9, further comprising a second sensor configured to sense second motion information related to the user's gestures.

11. The device of claim 10, wherein the second sensor is an artificial intelligence-based vision camera sensor.

12. The device of claim 3, wherein calculating the final data based on the first motion information includes calculating the final data if the first motion information performed in each manufacturing process matches pre-stored motion information matching data.

13. The device of claim 3, wherein the memory is configured to store the final data for each user account (ID).

14. An XR-based semiconductor manufacturing process training method, comprising:
storing virtual visual data, at least one spec data corresponding to parameters defined in each manufacturing process, and weights corresponding to the spec data;
sensing first motion information regarding user's movement;
receiving input data from the user;
determining set values for the parameters based on the input data, identifying the spec data to which the set values belong, assigning weights corresponding to the spec data to the set values, and calculating final data based on the first motion information and the weighted set values; and
displaying visual data corresponding to the virtual visual data and the final data.

15. The method of claim 14, wherein the step of calculating the final data comprises:
determining whether the spec data to which the set values belong matches the spec data with highest weights.

16. The method of claim 15, further comprising:
displaying predetermined first content for matching parameters if the spec data to which the set values belong matches the spec data with the highest weights; and
displaying predetermined second content for non-matching parameters if the spec data to which the set values belong does not match the spec data with the highest weights.

17. The method of claim 16, further comprising:
displaying predetermined third content if the number of non-matching parameters in each manufacturing process exceeds a predetermined number.

18. The method of claim 17, further comprising:
labeling each manufacturing process, the parameters defined in each manufacturing process, at least one spec data corresponding to the parameters, and the weights corresponding to the spec data as training data;
batch processing the labeled training data into a learning model;
extracting user recommendation data by inputting the final data, testing, and verifying the user recommendation data based on a pre-stored ground truth set;
generating feedback data based on the testing and verification; and
tuning the parameters of the learning model based on the feedback data to perform supervised learning of the user recommendation data for the user's final data.

19. The method of claim 14, wherein the step of calculating the final data based on the first motion information comprises:
calculating the final data if the first motion information performed in each manufacturing process matches pre-stored motion information matching data.

20. A non-transitory computer-readable storage medium storing instructions that, when executed by at least one processor of a computing system, cause the computing system to:
store virtual visual data, at least one specification data corresponding to parameters defined in each manufacturing process, and weights corresponding to the specification data;
sense first motion information regarding user's movement;
receive input data from the user;
determine set values for the parameters based on the input data, identify the specification data to which the set values belong, assign weights corresponding to the specification data to the set values, and calculate final data based on the first motion information and the weighted set values; and
display visual data corresponding to the virtual visual data and the final data.
